(19) United States
(12) Patent Application Publication
(10) Pub. No.: US 2016/0217436 A1
(43) Pub. Date: Jul. 28, 2016

(54) Method, System and Program Product for Tracking and Securing Transactions of Authenticated Items over Block Chain Systems.

(71) Applicant: Dror Samuel Brama, Jerusalem (IL)

(72) Inventor: Dror Samuel Brama, Jerusalem (IL)

(21) Appl. No.: 15/004,956

(22) Filed: Jan. 24, 2016

Related U.S. Application Data
(60) Provisional application No. 62/107,416, filed on Jan. 25, 2015.

(51) Int. Cl. G06Q 20/06; G06Q 20/38; G06Q 20/40; G06Q 20/10

(52) U.S. Cl. CPC G06Q 20/06; G06Q 20/10; G06Q 20/382; G06Q 20/401; G06Q 20/3827; G06Q 50/00

(57) ABSTRACT

A method, system and program product comprise accessing a system having a digital currency infrastructure. At least three user addresses are created. Rules for filtering acceptable transactions on the system are prepared in form of recursion base and recursion steps. Items are initiated on the system according to the defined rules. The assets transaction data is transferred to the system wherein the system links asset data and the parties to the transaction according to the said rules.

### CROSS-REFERENCE TO RELATED APPLICATIONS

The present Utility patent application claims priority benefit of the U.S. provisional application for patent Ser. No. 62/107,416 entitled “Method, System and Program Product for tracking and authenticating items by using block chain systems.”, filed on Jan. 25, 2015 under 35 U.S.C. 119(e). The contents of this related provisional application are incorporated herein by reference for all purposes to the extent that such subject matter is not inconsistent herewith or limiting hereof.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to data transfers. More particularly, the invention relates to data transfers emphasizing security and privacy.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many markets and trade of items may suffer from concerns about security, authenticity and/or privacy. In a non-limiting example, the difficulty to verify authenticity of items and systems through complex supply, distribution and service chains causes concerns about counterfeit items, tracking legally controlled items and security authenticating smart items.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art shows a method and system for an information collector to collect information from information suppliers and provide a history of transaction records for each item. By way of educational background, another aspect of the prior art generally useful to be aware of provides a computer program product for assembling a database comprising electronic enterprise resources records. Another such aspect of the prior art relates to systems and methods of utilizing the data captured in an integrated ERP and database software systems to cross-reference title of ownership with a specific item and its legal custodian, to maintain resource inventory, to verify or register a transfer of title for the item, and to conduct composite aggregations of system and parts for financial analytics and reporting. However, these solutions may be unable alleviate concerns of security and privacy of data. A solution which did and also could provide ability to track specific item or complete system and authenticate its chain from origin and do the authentication without the need to identify every party to a central database while enabling validated access to the data would be desirable.

In view of the foregoing, it is clear that these traditional techniques are not perfect and leave room for more optimal approaches.

### SUMMARY OF THE INVENTION

### Technical Problem

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art is “Block chain” based crypto currency or public ledger systems. In recent years, a lot of financial use cases are evolving around the ability to use block chain based or similar decentralized public ledgers for financial and other data transactions.

While systems for “track and trace”, and methods to authenticate an item exist, they use centralized registries and authentication of items in centralized methods, many times involving a lot of manual steps, identification of all parties such systems are not optimized and have high costs. The result is that fake items and fraud puts huge burden on industries that rely on authenticity, validity and tracking of complex supply and distribution chains. Non limiting examples include medicines, medical devices, designer items, controlled substances and many other physical items used in industrial systems, “Internet of things” capable devices, and other cases where there is a need to track chain of transactions for item or system with many items, without identifying each party of the chain to a central registry.

In view of the foregoing, it is clear that these traditional techniques are not perfect and leave room for more optimal approaches.

### Advantageous Effects

Elimination of fraud and fake items in medicine, medical devices, designer items, election systems and other industries where authenticity of an item is of value.

Tracking chains of ownerships and titles is easier and more effective based on public ledgers. Inclusion of hashable properties of items in transaction data on such ledgers further enables validation and verification of the item state in relation to its origin state.

The use of agreed rules recursion base and recursion steps as filters for determining legitimate transaction on such public ledger helps with compliance and accountability, enables real time view of asset flow from multiple sources to multiple destinations.

The ability to manage authenticity and legitimacy tokens of items or systems with many items as balance sheets and digital wallets enables protecting and verifying complex systems, in a non limiting example a the parts and systems of critical production infrastructure composed of many parts and system can be tracked for availability, authenticity and validation using queries on the decentralised blockchain, without requiring central party to hold the data and without requiring identification of some parties of the chain to others.

Auditors and researchers can have read-only access to live transaction data.

Messages and data items embedded in items will be readable to the compatible phone or “Point Of Sale” app.

Online markets of such first hand and second hand items can reduce fake and fraud problems.

It enables enforcing security and limitations on the transaction of items when required.

Items can communicate authenticity, legitimacy and authorization automatically to other items.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an overview illustration of an exemplary system for facilitating transfers between parties, in accordance with an embodiment of the present invention;

FIG. 2 is an illustration of an exemplary method for making data available to other users, in accordance with an embodiment of the present invention;

FIG. 3 is an illustration of an exemplary method for the initiation of transfers of data between parties, in accordance with an embodiment of the present invention;

FIG. 4 is an illustration of an exemplary method for ongoing exchanging sets of data, in accordance with an embodiment of the present invention;

FIG. 5 is an illustration of the detailed steps of exemplary method for ongoing exchanging sets of data, in accordance with an embodiment of the present invention;

FIG. 6 is an illustration of an exemplary use case method for ongoing exchanging sets of data, in accordance with an embodiment of the present invention;

FIG. 7 is an illustration of an exemplary method for a different use case of exchanging sets of data, in accordance with an embodiment of the present invention;

FIG. 8 is an illustration of an exemplary method for ongoing exchanging sets of data regarding to divisible assets in accordance with an embodiment of the present invention;

FIG. 9 is an illustration of an exemplary method for ongoing exchanging sets of data regarding to verification of one block chain with another in accordance with an embodiment of the present invention;

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need

Some embodiments of the present invention may provide means and/or method for providing security and/or privacy of shared data. Some of these embodiments may also provide means and/or methods for effective transferring of data and/or communication between parties or items with digital identity in “the Internet of Things” concept.

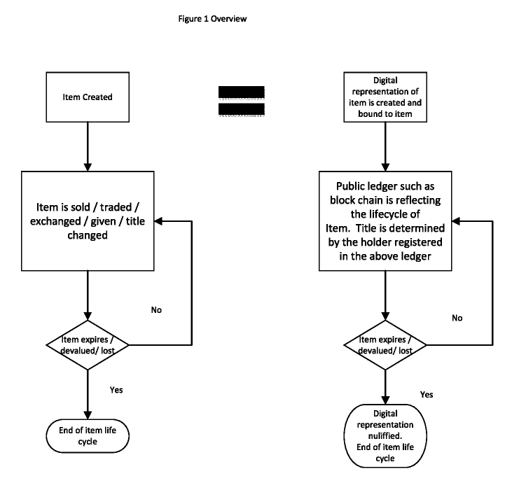

FIG. 1 is an overview illustration of an exemplary system for facilitating data transfers between parties, in accordance with an embodiment of the present invention. In a non-limiting example, suppose the subject of our trade is a physical asset such as garment, painting, a shoe, a watch, or similar objects that carry a brand name. The authenticity and or eligibility for trade is important to the trading parties. The following method enables a party to use block chain system to prove to others the authenticity and eligibility to trade the asset.

The manufacturer/creator/holder of the assets creates or acquires a pool of one or more digital addresses, which will represent the asset in the digital world, and digital tokens, which will reflect the “real world” “movement” (i.e. transactions) of the asset in the digital world. Based on a public decentralized ledger such as block chain system, users can follow the said tokens to enable tracking and authenticating the transaction cycles of the asset. In some embodiments, the said “address” of an item is derived or related by some computational hash algorithm to properties of the specific item. In non limiting example in some embodiments such properties are physical measures of the item such as dimensions or weight, in some embodiments such properties include hash of firmware or digital content of the item.

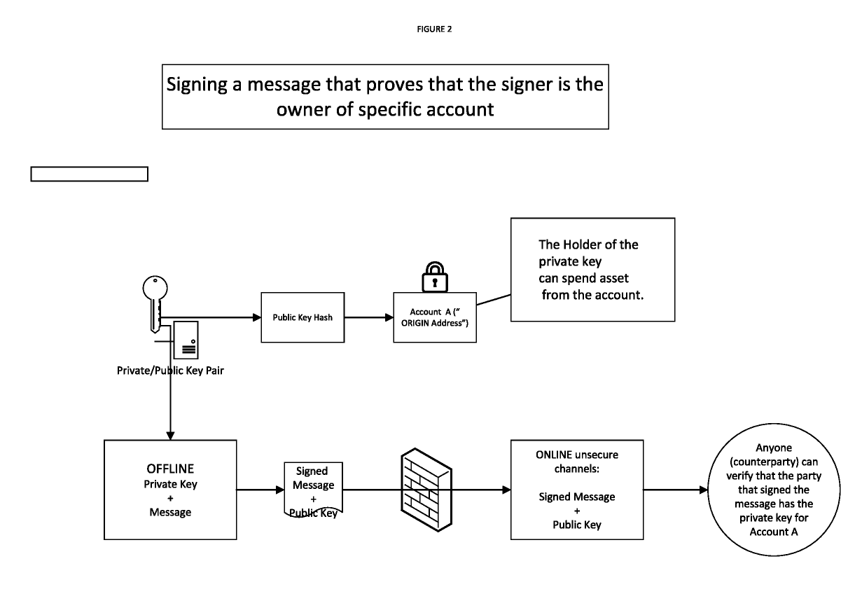

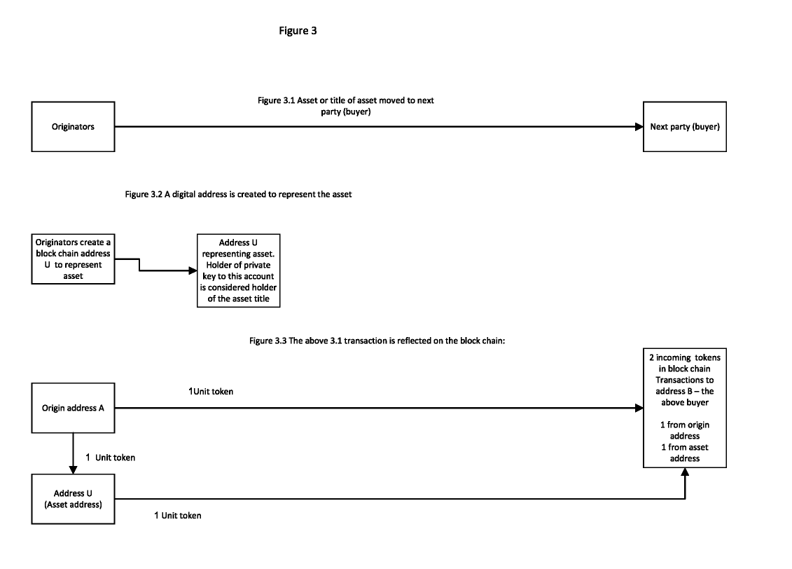

FIGS. 2 and 3 describe the process of initiating data transfer of items on the system in accordance with an embodiment of the present invention. The initiation creates a recursion base agreed between the users of the system as filter for determining legitimacy of transactions on the system wherein:

FIG. 2: Step 1: refers to initiation of asset on the system: The origin transactions: The manufacturer or holders of the rights to the brand and or distribution of the asset use a private key to create a unique blockchain address that represents the asset. As a non-limiting example, such address can be similar to a bitcoin or other crypto currency system address. For instructional purposes, we call this party the originators. In some embodiments, the originators will publish a signed message by the same private key to demonstrate that they are in control of that origin address.

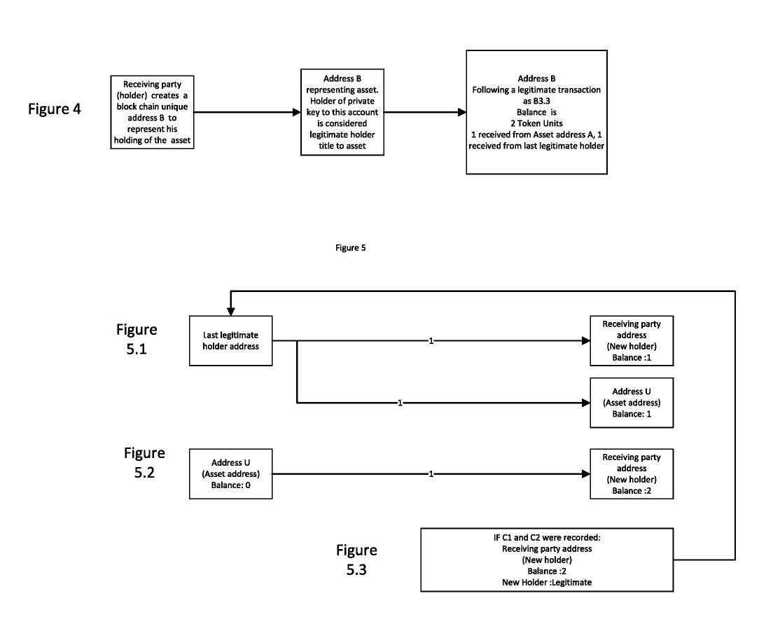

FIG. 3 step 2: When the originators transfer the asset to the next party for the first time, (as a non-limiting example: a distributer) (FIG. 3.1) they create a block chain address that will represent the asset (Address U, FIG. 3.2). They send 2 units of this block chain “currency” from the origin address. 1 unit is sent to the address of this asset. The second unit is sent to a unique address B (will be detailed in FIG. 4) held by the distributer (FIG. 3.3).

Since only the originators hold the private key of the asset “address”, they are the only party that can send units from it to other addresses. Whenever they receive a legitimate transaction on this address, they forward the token that they received to the legitimate receiver of the trade. In the above example (FIG. 3), the transfer of goods from the originators to the distributer is defined as a legitimate transaction; they will send the token unit to the distributer.

These steps complete the origin sequence. For instructional purposes the recursion base step was illustrated by the use of two tokens, as it is apparent to those skilled in the art the use of 2 token units is a simplified example of N token units that construct the origin sequence as recursion base. In some embodiments additional steps are added to the origin sequence, in non limiting example additional N source parties are added to the recursion base steps and N+1 token are transacted to the “asset” address.

FIG. 4: The transaction logged on the block chain shows that the unique address the receiving party has dedicated to the asset holds in its balance 2 token units. One received from the former legitimate holder of the asset, the second token was received from the asset itself (ie: the address representing the asset). When this is the case, the transaction is deemed legitimate by the proposed system. The instructional use of the term “private key” is a non-limiting example, in some embodiments it may be multiple keys for requiring multiple signatures for transfer approval, or other conditions common in blockchain system such as script hashes.

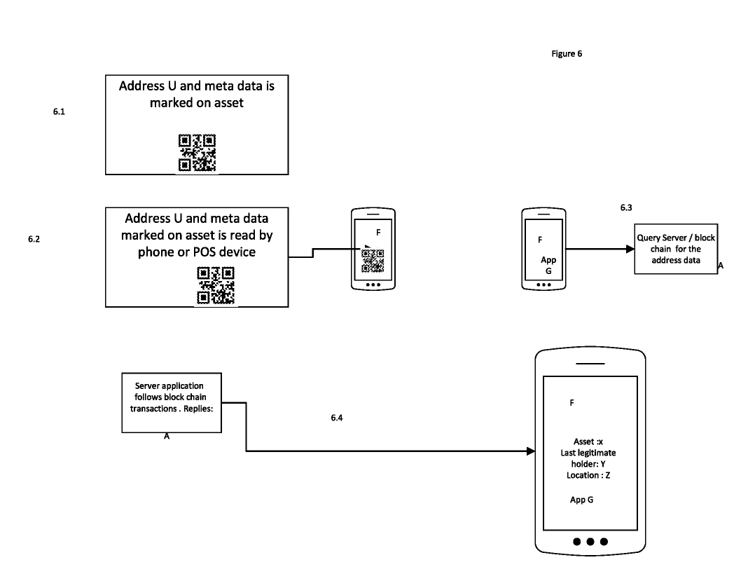

FIG. 5 is an illustration of an exemplary method for making data available to other users in further transactions, in accordance with an embodiment of the present invention as recursion steps filter for legitimacy of transaction in the system. A transfer of the asset on the block chain system by means of transaction is considered by the system to be legitimate if the following is logged in the block chain system used for tracking the asset:

A transaction from the last legitimate address that satisfies the following conditions:

Sent 1 unit (token) to the receiving party and (FIG. 5.1)

Sent 1 unit (token) to the asset address. (FIG. 5.1)

Followed by a transaction from the asset to same address of the receiving party. (FIG. 5.2)

No address other than originators can hold more than 2 units.

Only if all the above conditions were fulfilled, and a number of blocks are recorded in the chain on top of this transaction are considered sufficient by the parties as block chain validity, a transaction would be considered legitimate. (FIG. 5.3)

In some embodiments additional steps are added to the recursion sequence, in non limiting example above additional N source parties were added to the recursion base steps and N+1 token are transacted to the “asset” address, so matching rules and steps are added to the recursion steps to hold its validity.

FIG. 6: In one embodiment, a user may use an electronic device F to communicate bi-directionally with one or more servers or nodes in a peer to peer system A. In some embodiments, servers or nodes in a peer to peer system may store and/or manage various types of information including, without limitation, user-provided data and pointers to locations of data. In the present embodiment, servers or nodes in a peer to peer system A may communicate bi-directionally with other electronic devices F to facilitate communication between multiple users. In some embodiments, servers or nodes in a peer to peer system A may be suitable for processing sets of data according to principles of block chain systems of crypto currencies. In a non-limiting example, a first set of data may be a pointer to a location of a second set of data. In some embodiments, some sets of data may be publically viewable and others may have restricted access. In many embodiments, the user of device F can add app G to the functionality of his wallet or device. In many embodiments, app G enables the client to utilize additional services offered by block chain system B.

FIG. 6.1 is an illustration of an exemplary method for making data available to other users, in accordance with an embodiment of the invention. The parties may choose to physically mark the item with a machine-readable form, or publish its “address” or the public key assigned to it by the current holder. In some embodiments, the address may be related or derived from hash of item physical or software properties such as firmware, dimensions, weight, or similar properties that can be hashed using common hashing algorithms.

Knowing this “address” will enable their counterparty (as a non-limiting example: a customer, or an automated system) to point their mobile phone F to the item and get automated verification of the authenticity and/or legitimacy of the item. In (Figures C5-C7) a non-limiting example of the steps for such verification is illustrated.

FIG. 6.2 In many embodiments, user uses a mobile phone to read a machine-readable data printed on an item. An application decodes from the scan or reading the unique address assigned to the item, and the relevant block chain system that is tracking it.

FIG. 6.3 In many embodiments the application G queries a server with access to the relevant block chain system as to the available data on the item.

FIG. 6.4 In many embodiments, the server queries the relevant block chain by following the chain of legitimate transactions involving the item back to the origin. The recursive property described above enables efficient data queries because validating the last recursion cycle is sufficient to prove the chain from the origin. In some embodiments the query might return the full chain for auditing or other purposes.

The server sends data to be presented to the requesting party. The data may include some or all the following information: The address of last registered holder of the item on the block chain, the uniqueness of the item, its authenticity, the chain of former ownerships and transactions with the item. In some embodiments it will also enable validation of the said hashed properties of the item.

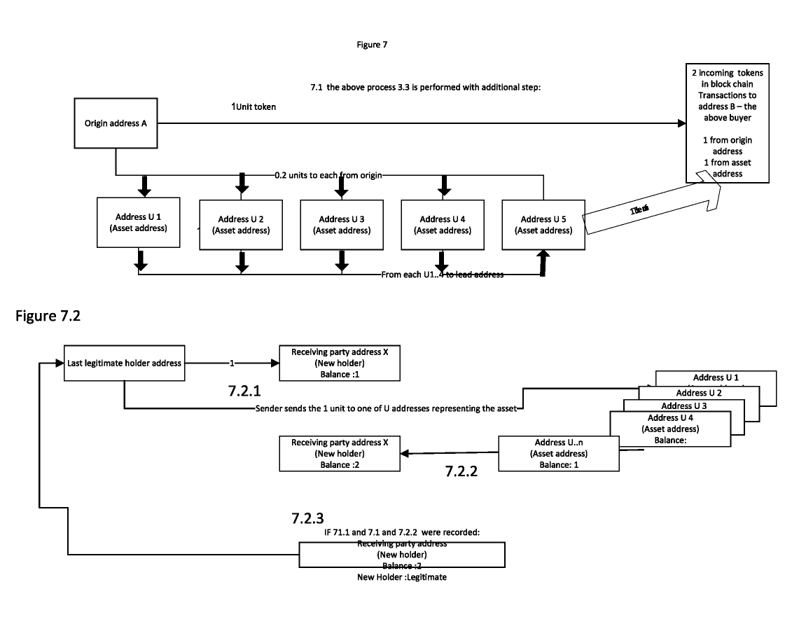

FIG. 7 is an illustration of an exemplary embodiment method for exchange of data, in accordance with an embodiment of the present invention. In the present embodiment, the parties wish to record more information about the transaction or the asset, such as rating for the asset or the seller. In this embodiment, rather than allocating one address to an asset, the originator allocates a group of addresses to represent it. (FIG. 7.1) As a non-limiting example, there are 5 addresses representing the asset. In step 2 (FIG. 7.1) above, the origin sequence of step will add a preliminary step: the originators will send 0.2 units to each of them, and forward from 4 of those addresses to the fifth. By following this initial process, the block chain will record the asset being represented legitimately by any of the above example 5 addresses. The sequence continues as before, but in every transaction, the “asset address” is one of a defined group. Each address represents an attribute relates to the asset such as rating of its quality. The sending party chooses to which address of the asset they send the token, whereby expressing their choice in the attributed value. (FIG. 7.2.1)

The choice of specific address of asset out of the set of addresses tied to the asset by the above (7.2.1) process, records on the block chain an additional parameter about this transfer. In a non-limiting example it can be rating or opinion about a parameter, about the transaction, or any other publicly agreed set of values attributed to the set of address by the originators. The holder of the asset send one token unit back to the receiving party (FIG. 7.2.2), and thus complete the transaction cycle. In the present embodiment, once the block chain has recorded this sequence, to the amount of blocks in the chain that is acceptable to the parties, the new holder is considered legitimate.

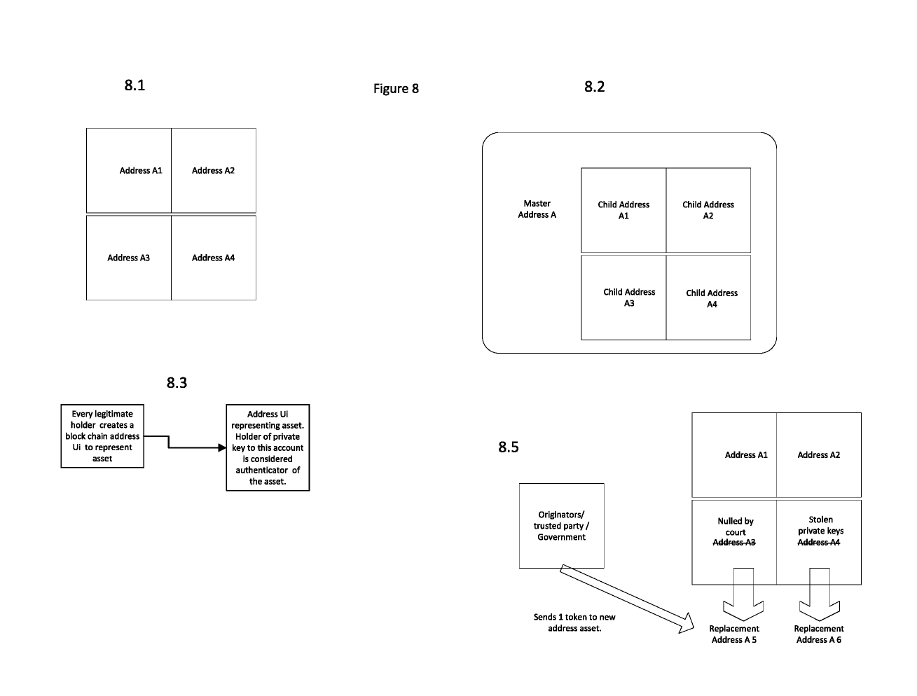

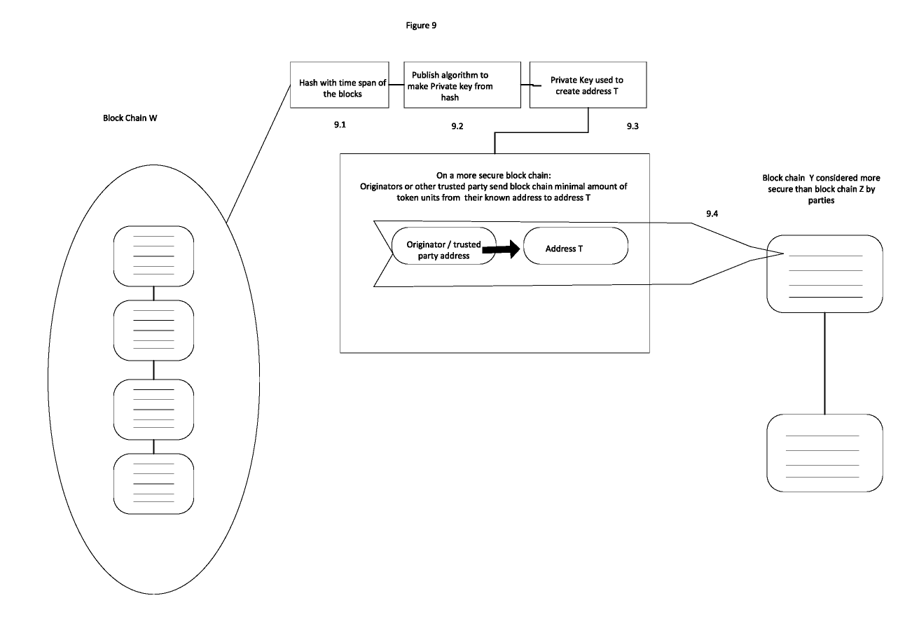

FIG. 8: The above examples use movable non-dividable object in the trade. In some embodiments, similar system can be used to trade assets that can be divided, and to assert the current ownership using similar block chain procedures.

FIG. 8.1: In a non limiting example, legitimate holder (such as owner, custodian, broker and similar) of a commercial real estate property wants to enable trade of the property, as a whole or in parts.

In some embodiments, the holder will be the originator. (FIG. 8.1) he will divide the asset to the atomic trade units (as a non-limiting example: 1 square feet). The originator will assign an address for each unit.

FIG. 8.2: In some embodiments, the address may be a mathematical hash derived from a parent address, so that one parent address can be used to represent the property as a whole, and the derived (“child”) addresses can be used to represent each partial unit. In some embodiments, the parent-child hash function may be published. In some embodiments, this hash may be reversible. so in some embodiments knowing the address of the main property will enable other parties to derive all the addresses of the units in it and vice versa, in some other embodiments only one side can be deduced from the other, so knowing one address can reveal the parent or the child but not vice versa. In the origin transaction the originator will send 1 token to the address of the unit and or the property, and one token to the addresses of the parties currently in possession of the asset.

FIG. 8.3: For instructional purposes, the above embodiment example presented the simplest form of validity recursion of transactions. It is apparent that additional steps may be added to the recursion In some embodiments, a non limiting example of extra step is shown in FIG. 8.3 where the party verifying the authenticity and legitimacy of the transfer is still the holder of the private key for the address representing the asset, but this holder may or may not be the originator, it can be the current holder of the asset. In some embodiments such steps enable the tracked assets to satisfy the validity of the chain of transactions without involving the originators in every transaction.

FIG. 8.4: In some embodiments, the originator or other trusted parties will may publish list of blocked addresses, to enable participants in the system to solve cases of proven theft of item, loss or theft of private keys, or similar situations where an address of an asset is decided by the agreements between participants or legally by regulators to be deemed null, or when forced transfer of an asset is required by court order or similar events.

In some embodiments, the block chain validation “proof of work” system is not computationally strong enough to protect the system from malicious party launching 51% attacks on the system. In many embodiments, the recursion enables verification requiring only validation of the former recursion cycle. This enables a system that holds a more secure block chain to be used to validate chain of blocks from other block chain systems. In a non limiting example, a chain of blocks can be hashed by the originators, government registry or other trusted party and expressed as a single transaction on a more secure block chain. An non limiting example use case of such system is block chain registry of real estate, which is hashed monthly to a represent official registry, or embedding such hash on the bitcoin block chain.

FIG. 9: is an illustration of the steps parties would use to secure the track and trace block chain over another block chain which is considered more secure by parties in accordance with this innovation. In some embodiments, the tracking and authentication of items is conducted using block chain W. The parties consider block chain Y to be more secure and resistant to attacks. Block chain Y may have different rules and protocols from block chain W. As a non-limiting example, bitcoin crypto currency block chain can be used as block chain Y to illustrate the steps.

FIG. 9.1: The originators or other trusted party creates a hash of a set of blocks from block chain W, including the time span. As a non-limiting example, hash of all blocks headers from previous week. The hashing method and time span rules is made public.

FIG. 9.2: Using another public hashing method, they create a private key from the above hash and use it to create a bitcoin address.

FIG. 9.3: Using above private key and they create a bitcoin address T.

FIG. 9.4: They create transaction compatible with block chain Y, where they send minimal acceptable amount of token units from their known address on block chain Y to this new address T. This transaction is recorded on block chain Y.

By repeating the above steps, and knowing the time span rules, any party with read access to block chain W and Y can verify whether the blocks on block chain W match the hash used in the transaction in block chain Y. Since only the originators or the trusted party holds the keys to their address on block chain Y, no other party can fake the validation of block chain W.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

What is claimed is:

1. A method comprising the steps of:
accessing a system having a digital currency infrastructure;
creating at least three user addresses;
designating addresses to source and target parties for transaction and address for item data; and transferring said data to said system wherein said system links said source and said target addresses with item data according to recursion base set of rules.

2. The method as recited in claim 1, in which said preparing further comprises encoding additional data in relation to transfer data as digital currency transactions and rules of recursion steps over said system.

3. The method as recited in claim 1, in which said preparing further comprises encoding additional properties of an item as digital currency transactions over said system.

4. The method as recited in claim 2, in which a public side of said digital currency infrastructure is used in an automated market for authentication and validation for said item data.

5. The method as recited in claim 4, in which said digital currency infrastructure is used to anonymously verify hashes and legitimacy for systems composed from multiple items from multiple sources using said system.

6. The method as recited in claim 1, in which said digital currency infrastructure is used to secure distribution and supply chains with separation between authentication and identification of participating parties.

7. The method as recited in claim 2, in which said digital currency transactions further comprises tickets for permission and decryption of data held by a third party.

8. The method as recited in claim 2, in which another ledger of digital currency infrastructure is used as a public provenance reference for compressed chain of blocks from said system.

9. The method as recited in claim 1, in which live flow auditing of items using said digital currency infrastructure facilitates a secure market of commerce in which items are known to be legitimate and authentic by said recursion.

10. A system comprising:
a digital currency infrastructure in which at least three user addresses is created, and prepared source and target and item related data is transferred to the system wherein the system links said source and target data and said item address according to recursion rule set.

11. The system as recited in claim 10, further comprising:
a unit configured for hashing a piece of item data said to address;
a unit configured for encoding and decoding recursion step data into transactions condition formats;
a unit configured for generating a special transaction that serves as recursion base step for item; and
a unit configured for extracting a message embedded in a transaction, in which source and target data is encoded as conditions on digital currency transactions and messages, hashes of item properties are anonymously encoded as financial transactions, a public side of said digital currency infrastructure is used in an automated secure validation market for said item data, said digital currency infrastructure is used to anonymously secure systems of multiple sources and target supply and distribution chain using said data, said digital currency infrastructure is used to enable verifying origin or legitimate holders anonymously, said digital currency transactions further comprises tickets for permission and decryption of user data held by a third party, a public ledger of said digital currency infrastructure is used as a public reference for auditing and researching item transactions on said public ledger, and using said digital currency infrastructure facilitates an open market of authenticated and legitimate items.

12. A non-transitory computer-readable storage medium with an executable program stored thereon, wherein the program instructs one or more processors to perform the following steps:
accessing a system having a digital currency infrastructure;
creating at least three user address;
designating addresses to source and target parties for transaction and item data; and transferring said data to said system wherein said system links said source and said target addresses with item data according to recursion base set of rules.

13. The program instructing the processor as recited in claim 12, in which said preparing further comprises encoding additional data in relation to transfer data as digital currency transactions and recursion steps over said system.

14. The program instructing the processor as recited in claim 12, in which said preparing further comprises encoding additional properties of an item as digital currency transactions over said system.

15. The program instructing the processor as recited in claim 13, in which a public side of said digital currency infrastructure is used in an automated market for authentication and validation for said item data.

16. The program instructing the processor as recited in claim 15, in which said digital currency infrastructure is used to anonymously verify hashes and legitimacy for systems composed from multiple items from multiple sources using said system.

17. The program instructing the processor as recited in claim 12, in which said digital currency infrastructure is used to secure distribution and supply chains with separation between authentication and identification of participating parties.

18. The program instructing the processor as recited in claim 13, in which said digital currency transactions further comprises tickets for permission and decryption of data held by a third party.

19. The program instructing the processor as recited in claim 13, in which a public ledger of another digital currency infrastructure is used as a public reference a another ledger of digital currency is used as a public provenance reference for compressed chain of blocks from said system.

20. The program instructing the processor as recited in claim 13, in which live flow auditing of items using said digital currency infrastructure facilitates a secure market of commerce in which items are known to be legitimate and authentic.
